(19) United States
(12) Patent Application Publication
(10) Pub. No.: US 2018/0199752 A1
(43) Pub. Date: Jul. 19, 2018

(54) BREWING QUALITY MEASURING DEVICE

(71) Applicant: BenQ ESCO Corp., Taipei City (TW)

(72) Inventor: Hung-Wen Chiou, Hsinchu City (TW)

(73) Assignee: BenQ ESCO Corp., Taipei City (TW)

(21) Appl. No.: 15/848,055

(22) Filed: Dec. 20, 2017

(30) Foreign Application Priority Data
Jan. 18, 2017 (TW) 106101690

(51) Int. Cl. A47J 31/40; A47J 31/56

(52) U.S. Cl. CPC A47J 31/40; A47J 2202/00; A47J 31/56

(57) ABSTRACT

A brewing quality measuring device including an electronic scale, a thermometer, a position maintaining device and an operating/control unit is provided. The electronic scale includes a platform used for placing a container having a brew therein. The thermometer has a measuring portion. The position maintaining device is used for holding the measuring portion of the thermometer at a measuring position. The operating/control unit is used for receiving measuring signals from each of the electronic scale and the thermometer. The measuring position corresponds to a specific position of the container when the container is placed on the platform, so that the thermometer measures the temperature of the brew at the measuring position.

This application claims the benefit of Taiwan application Serial No. 106101690, filed Jan. 18, 2017, the subject matter of which is incorporated herein by reference.

### BACKGROUND OF THE INVENTION

### Field of the Invention

The invention relates in general to a measuring device, and more particularly to a brewing quality measuring device.

### Description of the Related Art

Tea and coffee, which have long been regarded as important economic crops to people since the antiquity, are most popular brew to modern people. Many people are used to drinking a cup of instantly brewed tea or hot coffee to refresh themselves. Therefore, various tastes of tea and coffee are provided.

Tea and coffee have a large variety, and different varieties require different lengths of brewing time and temperatures. If the brewing time and temperature are insufficient, the fragrance and taste of tea and coffee cannot be fully released. If the concentration of the brew is too low or too high, the taste will be too light or too strong, and the brewing quality will be greatly affected. In the market of instant brew, the brewing of tea and coffee largely relies on personal experience, and the temperature and concentration of the brew are not quantified. Therefore, the brewing quality is unstable and people's purchase intention will be discouraged.

### SUMMARY OF THE INVENTION

The invention is directed to a brewing quality measuring device capable of analyzing and monitoring the brewing quality, so that the temperature and weight (or concentration) of the brew can be quantified and the brewing quality can be improved.

According to one embodiment of the invention, a brewing quality measuring device including an electronic scale, a thermometer, a position maintaining device and an operating/control unit is provided. The electronic scale includes a platform used for placing a container having a brew therein. The thermometer has a measuring portion. The position maintaining device is used for holding the measuring portion of the thermometer at a measuring position. The operating/control unit is used for receiving a measuring signal from each of the electronic scale and the thermometer. The measuring position corresponds to a specific position of the container when the container is placed on the platform, so that the thermometer measures the temperature of the brew at the measuring position.

According to another embodiment of the invention, a brewing quality measuring device including an electronic scale, a thermometer, an operating/control unit and a communication interface is provided. The electronic scale includes a platform used for placing a container having a brew therein. The thermometer has a measuring portion. The operating/control unit is used for receiving a measuring signal from each of the electronic scale and the thermometer. The operating/control unit is coupled to the communication interface used for transmitting the measuring signal to a remote data monitoring center.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an element block diagram of a brewing quality measuring device according to an embodiment of the invention.

FIG. 2 is an external view of a brewing quality measuring device according to an embodiment of the invention.

FIGS. 3A-3C respectively show a position maintaining device being placed horizontally or vertically or bent to a predetermined shape.

FIG. 4 is a schematic diagram of angle fixing elements disposed at each joint of the position maintaining device.

FIG. 5 is a schematic diagram of an operating panel of an electronic scale.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention.

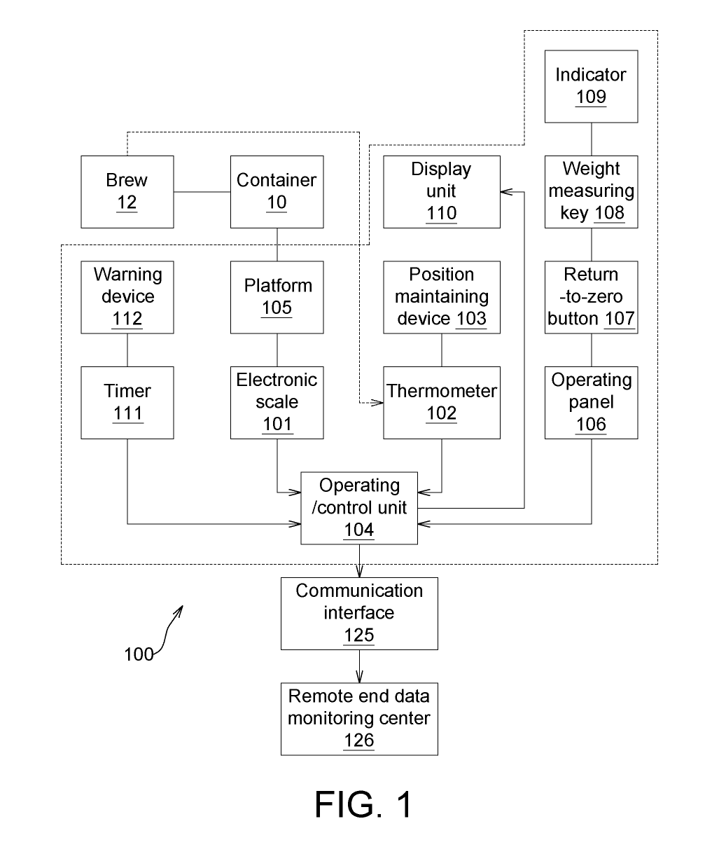

Refer to FIG. 1. The brewing quality measuring device 100 according to an embodiment of the invention is used for measuring the brewing quality of a brew 12 in a container 10. The brewing quality is based on factors such as the weight, the concentration, the temperature or other relevant brewing data of the brew. The brew 12 can be tea, coffee or anything that can be brewed with hot water.

Examples of most commonly seen factors affecting the brewing quality include hot water temperature, concentration (the proportion of water to the brew), brewing time, number of brews, size of coffee grind, weight, variety and harvest season. Normally, better brewing effect can be achieved if tea or coffee is brewed with hot water having a temperature of 85° C. to 100° C. for a period of time. Before coffee is brewed, factors such as the weight, grind size and variety of coffee can be predetermined by an automatic brewing machine and hot water temperature can also be set by the automatic brewing machine, so that better brewing effect can be achieved.

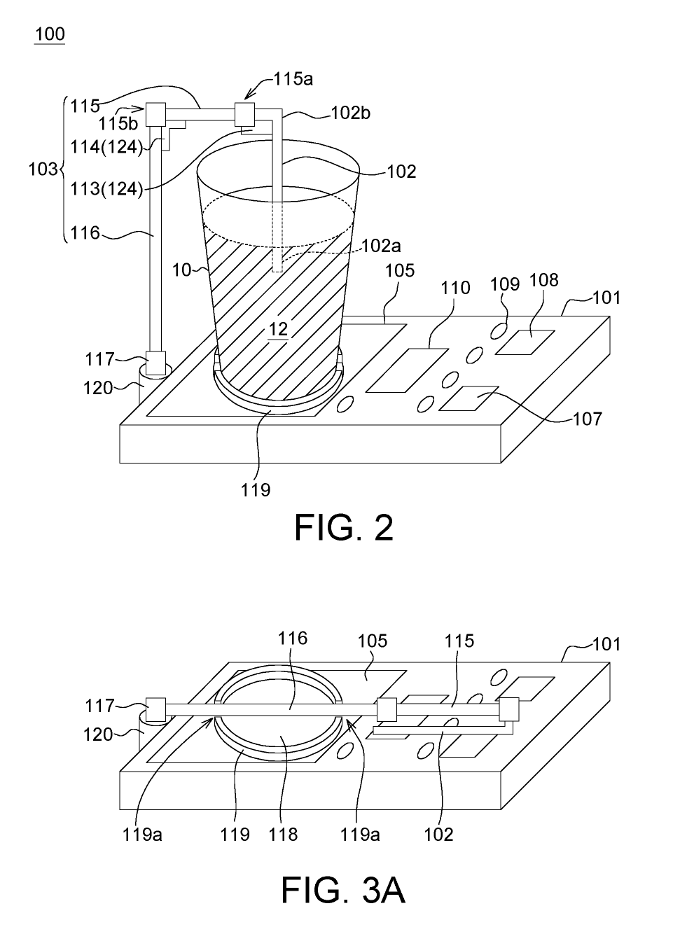

In the present embodiment, a brewing quality measuring device 100 is used for quantifying the temperature and weight (or concentration) of the brew of tea or coffee. The brewing quality measuring device 100 includes an electronic scale 101, a thermometer 102, a position maintaining device 103 and an operating/control unit 104. Refer to both FIGS. 1 and 2. The electronic scale 101 includes a platform 105 used for placing a container 10 having a brew 12 therein. The container 10 is a paper cup, for example. After the brew 12 was infused to the container 10 from an automatic brewing machine, the container 10 can be placed on the platform 105 used for measuring the weight of the brew 12. In an embodiment, if the brew is brewed with too much hot water, the concentration of the brew will be too low. Conversely, if the brew is brewed with too less hot water, the concentration of the brew will be too high. Therefore, the operating/control unit 104 can show the brewing data such as the weight (or the concentration) of the brew on a display unit 110 (such as a liquid crystal display) according to a measuring signal received from the electronic scale 101, and the user can see and obtain the brewing data relevant to the brewing quality of the brew 12.

Refer to FIGS. 1 and 2. The thermometer 102 has a measuring portion 102a, and the position maintaining device 103 is used for holding the measuring portion 102a of the thermometer 102 at a measuring position. In an embodiment, when the container 10 is placed on the electronic scale 101, the position maintaining device 103 enables the front end of the thermometer 102 (equipped with a thermal sensor) to be inserted into the container 10 and fixed at a specific position, so that the measuring position corresponds to a specific position of the container 10. Normally, the temperature of the brew 12 measured at a position closer to the center point of the container 10 is more accurate and has smaller variation than that measured at a position closer to the surface or lateral side of the container 10. Therefore, when measuring the temperature of the brew 12, the measured temperature may vary with the measuring position. To avoid man-caused measurement errors, in an exemplary embodiment, the position maintaining device 103 is for fixing the measuring portion 102a of the thermometer 102 close to the center point of the container 10, so that the thermometer 102 can accurately measure the center temperature of the brew 12 to obtain better brewing data.

After the thermometer 102 measured the center temperature of the brew 12, the operating/control unit 104 can show the brewing data relevant to the brewing quality of the brew 12, such as the brewing temperature, on the display unit 110 according to a measuring signal received from the thermometer 102, so that the user can see and obtain the brewing data relevant to the brewing quality of the brew 12. Refer to FIG. 2. Apart from fixing the thermometer 102 at a measuring position, the position maintaining device 103 further has a signal connection portion 117 electrically connected to the thermometer 102 for transmitting the measuring signal of the thermometer 102 to the operating/control unit 104 disposed inside the electronic scale 101. The signal connection portion 117 can be pluggably or bendably disposed on the base 120 of the electronic scale 101. When the signal connection portion 117 is inserted into or vertically disposed on the base 120 of the electronic scale 101, the power switch will be turned on, so that quality assessment or data analysis can be started. Conversely, when the signal connection portion 117 is removed from or horizontally disposed on the base 120 of the electronic scale 101, the power switch will be turned off and the measurement will be terminated. In another embodiment, the user can press a button on the operating panel 106 to turn on/off the power switch, and the invention does not impose specific restrictions regarding the power switch.

Refer to FIG. 2. The position maintaining device 103 includes a first fixer 113, a second fixer 114, a horizontal arm 115 and a vertical arm 116. The horizontal arm 115 is connected between the thermometer 102 and the vertical arm 116, such that the position maintaining device 103 and the thermometer 102 can be combined to form a 7-shaped structure. The first fixer 113 and the second fixer 114 are disposed at two corners of the 7-shaped structure. That is, the first fixer 113 is fixed at the shaft end 115a between the thermometer 102 and the horizontal arm 115 to limit the rotation of the thermometer 102 with respect to the horizontal arm 115. The second fixer 114 is fixed at the shaft end 115b between the horizontal arm 115 and the vertical arm 116 to limit the rotation angle of the horizontal arm 115 with respect to the vertical arm 116 to 90°.

As indicated in FIG. 2, the thermometer 102 has a measuring portion 102a and a fixing end 102b opposite to the measuring portion 102a. The horizontal arm 115 has a first shaft end 115a and a second shaft end 115b opposite to the first shaft end 115a. When the measuring portion 102a of the thermometer 102 is at the measuring position, the first shaft end 115a of the horizontal arm 115 is fixed by the first fixer 113, so that the angle between the horizontal arm 115 and the thermometer 102 maintains at about 90°. When the vertical arm 116 is vertically disposed on the electronic scale 101, the second shaft end 115b of the horizontal arm 115 and the vertical arm 116 are fixed by the second fixer 114, so that the angle between the horizontal arm 115 and the vertical arm 116 maintains at about 90°. In an embodiment, the first fixer 113 can be a horizontal fixer or a right angled fixer; and the second fixer 114 can be a horizontal fixer or a right angled fixer. However, the invention is not limited thereto.

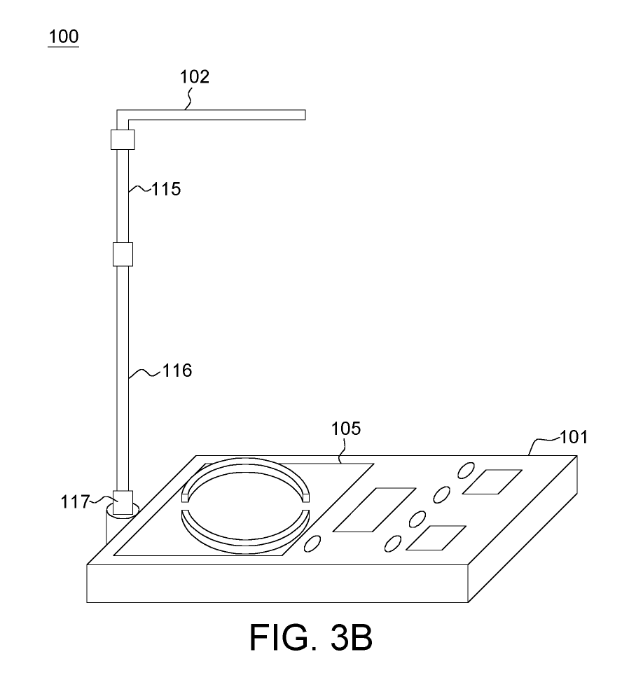

Refer to FIG. 3A. After the first fixer 113 and the second fixer 114 are removed, the vertical arm 116 and the horizontal arm 115 can be straightened, rotated and horizontally disposed on the electronic scale 101, so that the vertical arm 116 and the horizontal arm 115 and the folded thermometer 102 can be horizontally disposed on the electronic scale 101 for the convenience of storage. Refer to FIG. 3B. When the vertical arm 116 and the horizontal arm 115 are vertically disposed on the electronic scale 101, the thermometer 102 is fixed on the horizontal arm 115 in a vertical state. Meanwhile, the height of the thermometer 102 is higher than that of the opening of the container 10 to enhance operating convenience, so that the user can place the container 10 having the brew 12 therein on the platform 105. Refer to FIG. 3C. When the horizontal arm 115 is rotated to a predetermined position with respect to the vertical arm 116, the measuring portion 102a of the thermometer 102 is exactly at the measuring position, so that the problem of inaccurate positioning caused by operating errors can be avoided.

Refer to FIGS. 3A-3C. The platform 105 includes a center portion 118 and an outer ring 119 protruded with respect to the center portion 118 to form a flange. When the container 10 is placed on the platform 105, the bottom periphery of the container 10 is enclosed by the outer ring 119 and stably disposed on the center portion 118, so that the measuring position of the thermometer 102 corresponds to a specific position of the container 10 (such as the center position), and the problem of inaccurate positioning can be avoided. Refer to FIG. 3A. The outer ring 119 has two opposite recesses 119a whose width are approximately equivalent to the width of the vertical arm 116. When the vertical arm 116 is horizontally disposed on the electronic scale 101, the vertical arm 116 passes through the two recesses 119a, so that the storage height can be reduced. The vertical arm 116 can further be engaged with the sidewall of the two recesses 119a and fixed on the electronic scale 101.

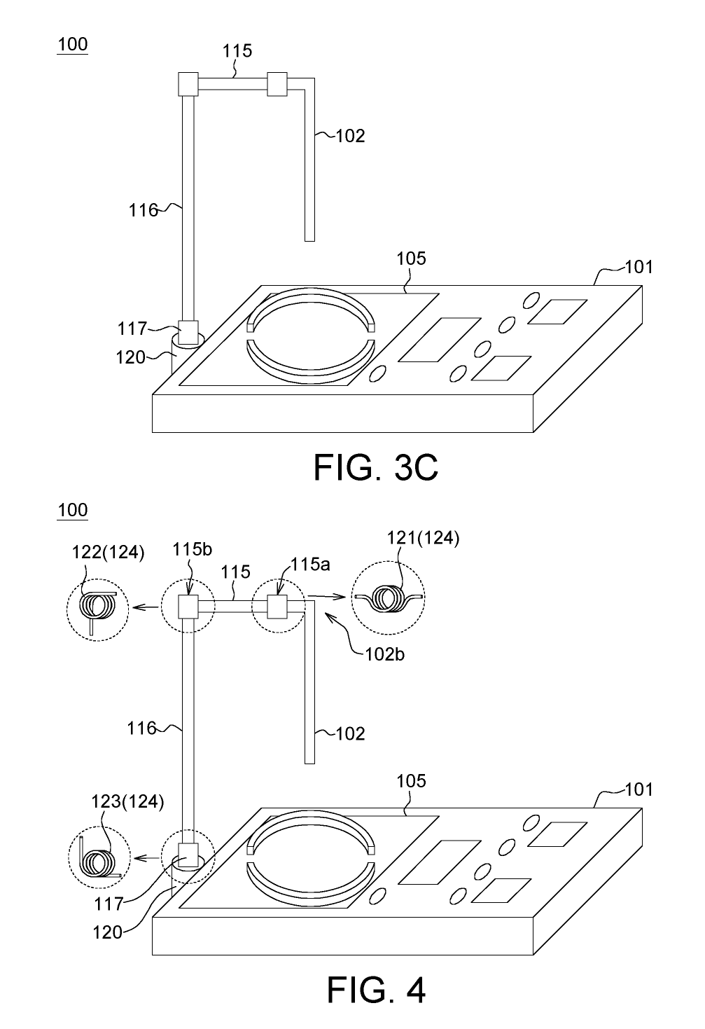

Referring to FIG. 4, a schematic diagram of angle fixing elements 124 disposed at each joint of a position maintaining device 103 is shown. That is, the angle fixing elements 124 can be realized by the first fixer 113 and the second fixer 114 as illustrated in FIG. 2 or the torsion springs as illustrated in FIG. 4. The two ends of the first torsion spring 121 form an angle of 180° and are respectively connected to the first end 115a of the horizontal arm 115 and the fixing end 102b of the thermometer 102, so that the angle between the horizontal arm 115 and the thermometer 102 is substantially maintained at about 90°. The two ends of the second torsion spring 122 form an angle of 90° and are respectively connected to the second end 115b of the horizontal arm 115 and the vertical arm 116, so that the angle between the horizontal arm 115 and the vertical arm 116 is substantially maintained at about 90°. The two ends of the third torsion spring 123 form an angle of 90° and are respectively connected to the vertical arm 116 and the base 120 of the electronic scale 101, so that the vertical arm 116 can be vertically disposed on the electronic scale 101. Though the above angular positioning, the measuring position of the thermometer 102 corresponds to a specific position of the container 10 (such as the center position), so that the problem of inaccurate positioning caused by measuring errors can be avoided.

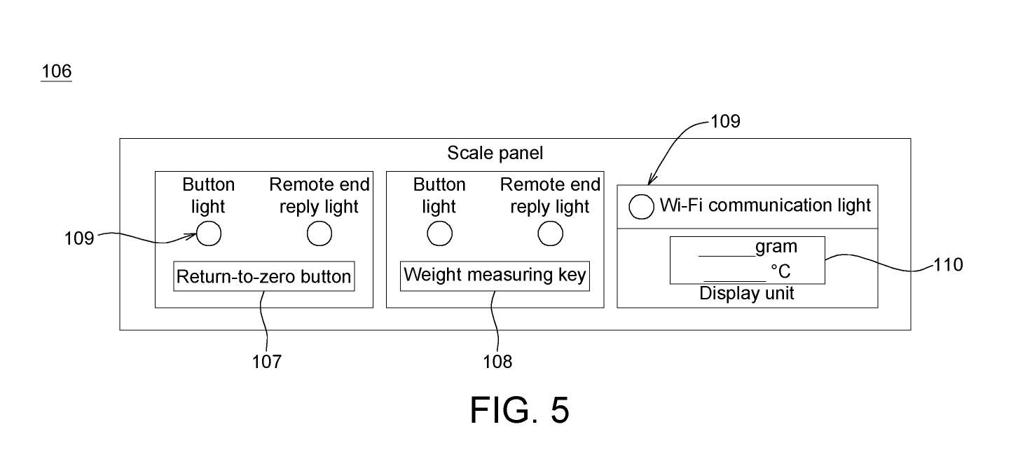

Refer to FIGS. 1 and 5. The brewing quality measuring device 100 further includes an operating panel 106 disposed on the electronic scale 101. The operating panel 106 includes a return-to-zero button 107, a weight measuring key 108 and at least an indicator 109 showing the current operating state. In an embodiment, when the container 10 is placed on the platform 105, the user presses the return-to-zero button 107 and the display unit 110 display a net weight of 0. Meanwhile, the indicator 109 of the return-to-zero button 107 displays a light signal. After the brew 12 was infused to the container 10 by an automatic brewing machine, the user places the container 10 on the platform 105 and presses the weight measuring key 108 to measure the net weight of the brew 12. Then, the user further displays the net weight of the brew 12 on the display unit 110. Meanwhile, the indicator 109 of the weight measuring key 108 displays a light signal.

In an embodiment, the brewing quality measuring device 100 is equipped with remote monitoring function, and the operating/control unit 104 can transmit a brewing data to a remote data monitoring center 126 through a cabled or wireless communication interface 125 so that the remote operator or the remote data monitoring center 126 can obtain the measuring result. As indicated in FIG. 5, the indicator 109 includes the functions of button light, remote reply light and Wi-Fi communication light, and the button light flashes or displays a light signal when the user presses the return-to-zero button 107 or the weight measuring key 108. Meanwhile, the operating/control unit 104 transmits a zero value or a weight measuring value to the remote data monitoring center 126 for quality control. When the remote reply light flashes or displays a light signal, this implies that the remote data monitoring center 126 has received the brewing data. When the Wi-Fi communication light flashes or displays a light signal, this implies that the brewing quality measuring device 100 is performing wireless communication or waiting for a remote reply. The remote operator or the remote data monitoring center 126 can remotely perform scale calibration on the brewing quality measuring device 100. Firstly, after a standard weight was placed at the center position of the platform 105 of the brewing quality measuring device 100, the brewing quality measuring device 100 transmits the measuring result to the remote data monitoring center 126, and the remote data monitoring center 126, based on the measuring result, further transmits calibration data to the brewing quality measuring device 100, which will perform calibration according to the calibration data. The calibration of the thermometer can adopt similar steps. Firstly, the thermometer is disposed in a standard temperature providing device, the brewing quality measuring device 100 transmits the measuring result to the remote data monitoring center 126, and the remote data monitoring center 126, based on the measuring result, transmits calibration data to the brewing quality measuring device 100 which will perform calibration according to the calibration data. Such remote calibration can avoid on-site operators committing errors during the calibrating operation.

On the other hand, the brewing quality measuring device 100 can further be equipped with timing and alerting functions. When the user presses the return-to-zero button 107 and activates a timer 111 but fails to press the weight measuring key 108 within a specified period of time, the operating/control unit 104, based on the return signal of the timer 111, will determine that abnormity occurs. Meanwhile, the operating/control unit 104 will transmit an abnormity notice signal to a warning device 112 to remind the user of the occurrence of abnormity. The warning device 112 can emit a light, sound or video signal to warn the user that abnormity occurs.

On the other hand, the brewing quality measuring device 100 can be connected to an automated electrical equipment through an Internet of Things which can perform a series of predetermined procedures to achieve specific processing or produce specific products. For example, the brewing quality measuring device 100 can be connected to the automatic brewing machine through the Internet of Things. The operator only needs to click the coffee type, such as Mocha or Latte, and the automatic brewing machine will activate a series of corresponding procedures to brew the desired coffee. The brewing quality measuring device 100 receives parameter values from the automatic brewing machine (such as the brewing time, the hot water temperature, the ratio of water to coffee, and the variety) and the operating data to determine whether the control procedure performed by the automatic brewing machine or the current operating stage complies with the standards or not. If the brewing quality measuring device 100 determines that the current operating state of the automatic brewing machine is abnormal, the operating/control unit 104 can emit an abnormity notice signal to the warning device 112 to remind the user of the occurrence of abnormity.

Conventionally, the control of brewing quality is based on personal experience. However, the brewing quality measuring device disclosed in above embodiments of the invention quantifies the temperature and weight (or concentration) of the brew, such that the brewing quality is relatively stable and can be improved. Therefore, the brewing quality measuring device of the invention can reduce the problem of unstable quality caused by manual brewing. The brewing quality measuring device is further equipped with remote monitoring function and capable of transmitting brewing data to a remote data monitoring center 126 through a communication interface 125. After obtaining the measuring result, the remote operator or the remote data monitoring center 126 can perform data analysis to enhance quality control and provide strategy of improvement.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A brewing quality measuring device, comprising:
an electronic scale, comprising a platform used for placing a container having a brew therein;
a thermometer having a measuring portion;
a position maintaining device used for holding the measuring portion of the thermometer at a measuring position; and
an operating/control unit used for receiving a measuring signal from each of the electronic scale and the thermometer,
wherein, the measuring position corresponds to a specific position of the container when the container is placed on the platform, so that the thermometer measures a temperature of the brew at the measuring position.

2. The brewing quality measuring device according to claim 1, wherein the position maintaining device is pluggably, vertically or horizontally disposed on the electronic scale.

3. The brewing quality measuring device according to claim 2, wherein the position maintaining device comprising a first angle fixing element, the thermometer has a fixing end opposite to the measuring portion, and the first angle fixing element is used for holding the fixing end of the thermometer.

4. The brewing quality measuring device according to claim 3, wherein the position maintaining device further comprises a horizontal arm coupled to the fixing end of the thermometer, and the first angle fixing element limits an angle between the fixing end of the thermometer and the horizontal arm.

5. The brewing quality measuring device according to claim 4, wherein the position maintaining device further comprises a second angle fixing element, the horizontal arm has a first shaft end coupled to the fixing end of the thermometer, and the horizontal arm has a second shaft end opposite to the first end and fixed by the second angle fixing element.

6. The brewing quality measuring device according to claim 5, wherein the position maintaining device further comprises a vertical arm coupled to the second shaft end of the horizontal arm, the second angle fixing element limits an angle between the second shaft end of the horizontal arm and the vertical arm.

7. The brewing quality measuring device according to claim 6, wherein the vertical arm is vertically disposed on the electronic scale, the vertical arm, the horizontal arm of the position maintaining device and the thermometer form a 7-shaped structure, and the first angle fixing element and the second angle fixing element are respectively disposed at two corners of the 7-shaped structure.

8. The brewing quality measuring device according to claim 7, wherein the first angle fixing element and the second angle fixing element are horizontal fixers, right angled fixers or torsion springs.

9. The brewing quality measuring device according to claim 1, wherein the electronic scale further comprises an operating panel comprising a return-to-zero button, a weight measuring key and at least an indicator displaying a current operating state.

10. The brewing quality measuring device according to claim 1, wherein the operating/control unit is coupled to a communication interface used for transmitting the measuring signals to a remote data monitoring center.

11. The brewing quality measuring device according to claim 1, wherein the platform comprising a center portion and an outer ring protruded with respect to the center portion to form a flange.

12. The brewing quality measuring device according to claim 1, wherein the brewing quality measuring device receive a calibration instruction from a remote data monitoring center for performing calibration on at least one of the electronic scale and the thermometer.

13. A brewing quality measuring device, comprising:
an electronic scale comprising a platform used for placing a container having a brew therein;
a thermometer having a measuring portion;
an operating/control unit used for receiving measuring signals from each of the electronic scale and the thermometer; and
a communication interface coupled to the operating/control unit for transmitting a measuring signal to a remote data monitoring center.

14. The brewing quality measuring device according to claim 13, wherein the brewing quality measuring device can receive a calibration instruction from the remote data monitoring center to perform calibration on at least one of the electronic scale and the thermometer.
